(19) United States
(12) Patent Application Publication
(10) Pub. No.: US 2008/0240669 A1
(43) Pub. Date: Oct. 2, 2008

(54) MPEG-BASED USER INTERFACE DEVICE AND METHOD OF CONTROLLING FUNCTION USING THE SAME

(75) Inventors: Seung-Jae OH, Seoul (KR); Kyung-Mo PARK, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/035,104

(22) Filed: Feb. 21, 2008

Related U.S. Application Data
(60) Provisional application No. 60/920,816, filed on Mar. 30, 2007.

(30) Foreign Application Priority Data
Apr. 25, 2007 (KR) 10-2007-0040372

(51) Int. Cl. H04N 7/00

(52) U.S. Cl. 386/46

(57) ABSTRACT

An MPEG-based user interface (UI) device and a method of controlling a function using the same are provided. The MPEG-based user interface (UI) device includes an output unit which outputs an MPEG-based UI to a screen of an apparatus, and a processing unit which controls a function corresponding to the UI.

### CROSS REFERENCE TO RELATED APPLICATION

This application claims priority from U.S. Provisional Application No. 60/920,816 filed on Mar. 30, 2007 in the United States Patent and Trademark Office, and Korean Patent Application No. 10-2007-0040372 filed on Apr. 25, 2007 in the Korean Intellectual Property Office, the disclosures of which are incorporated herein by reference in their entirety.

### BACKGROUND OF THE INVENTION

1. Field of the Invention

Apparatuses and methods consistent with the present invention relate to a Moving Picture Experts Group (MPEG)-based user interface device and a method of controlling a function using the same, and more particularly, to an MPEG-based user interface device, which provides a user interface using MPEG data, and to a method of controlling a function using the same.

2. Description of the Related Art

Multimedia includes text, still pictures, moving pictures, animation, sound, and the like. Among these, the moving pictures are fundamental to a next-generation video-on-demand (VOD) service or an interactive media service. The MPEG standard, which is considered to be superior to other standards for compressing and decompressing digital video data, is used to process video on a personal computer. Further, in order to realize a high-quality digital system, such as a high definition television (HDTV), improved versions in the MPEG standard have been made, such as MPEG-1, MPEG-3, and MPEG-4. For example, MPEG-4 is the core technology for an IMT-2000 multimedia service and the next-generation interactive Internet broadcasting. The MPEG-4 standard for multimedia moving picture compression effectively processes and transmits various formats of digital audio and video signals. Applications of the MPEG-4 standard include video-on-demand (VOD), videoconferencing, video phone, Internet broadcasting, multimedia advertisement, audio-on-demand (AOD), multimedia messaging service, and the like.

A user interface (UI) of a consumer electronics (CE) apparatus or a mobile apparatus is generally provided using HyperText Markup Language (HTML), Flash, or UI technology of the corresponding apparatus provided by the manufacturer. Therefore, the UI that is output to the apparatus may be affected by resolution. For example, when the UI, which is output to a cellular phone, is output to a digital TV on a magnified scale, the resolution of an original image of the UI may be reduced or noise may be generated. Further, a program, such as a browser, is needed to display the HTML, the Flash, or the like, which is used to provide the UI, on the apparatus.

Therefore, there is a need for a new type of UI based on the MPEG standard such that the UI can be expressed regardless of the resolution of the apparatus, and the CE apparatus or the mobile apparatus, which supports moving pictures with the MPEG standard, does not have the overhead for the UI.

### SUMMARY OF THE INVENTION

The present invention provides an MPEG-based UI device, which provides a high-quality multimedia type UI to a user, and a method of controlling a function using the same.

According to an aspect of the invention, there is provided an MPEG-based UI device, the MPEG-based user interface device including an output unit which outputs an MPEG-based UI to a screen of an apparatus, and a processing unit which controls a function corresponding to the UI.

According to another aspect of the invention, there is provided a method of controlling a function using an MPEG-based UI, the method including outputting an MPEG-based UI to a screen of an apparatus, and controlling a predetermined function corresponding to the UI.

### BRIEF DESCRIPTION OF THE DRAWINGS

The above and other aspects of the invention will become more apparent by describing in detail exemplary embodiments thereof with reference to the attached drawings in which:

FIG. 1 is a block diagram illustrating an MPEG-based user interface device according to an exemplary embodiment of the invention;

FIG. 2 is a diagram illustrating an example of a source code in the scene description according to an exemplary embodiment of the invention; and

FIG. 3 is a flowchart illustrating a method of controlling a function using an MPEG-based user interface according to an exemplary embodiment of the invention.

### DESCRIPTION OF EXEMPLARY EMBODIMENTS

Advantages and features of the invention and methods of accomplishing the same may be understood more readily by reference to the following detailed description of exemplary embodiments and the accompanying drawings. The invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the invention will only be defined by the appended claims.

The invention will now be described more fully with reference to the accompanying drawings, in which exemplary embodiments of the invention are shown.

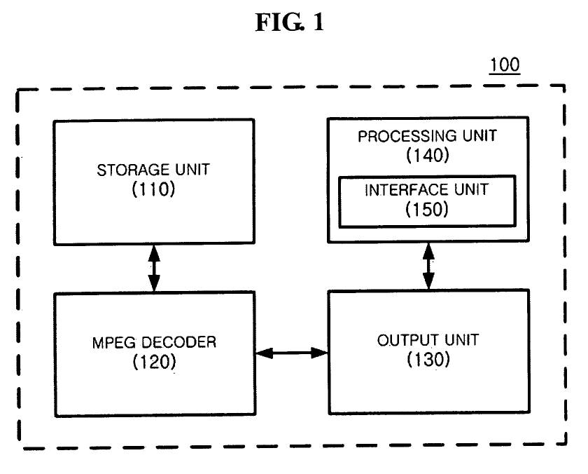

FIG. 1 is a block diagram illustrating an MPEG-based UI device according to an exemplary embodiment of the invention.

An MPEG-based UI device (hereinafter, simply referred to as a “UI device”) 100 includes a storage unit 110, an MPEG decoder 120, an output unit 130, and a processing unit 140. The components of the UI device 100 will now be described in detail.

The storage unit 110 stores MPEG data in an MPEG format. MPEG is an international standard for encoding and compressing digital video and audio, and includes MPEG-1, MPEG-2, MPEG-4, MPEG-7, and the like. The MPEG data stored in the MPEG format can be newly defined as so-called MPEG Graphic User Interface (GUI) according to the MPEG standard. The MPEG data can be transmitted by elementary streams or logical transmission channels. Further, the MPEG data may include information regarding the object description and scene description.

The object description describes a media object (hereinafter, simply referred to as an “object”) and includes information on metadata related to the object, such as contents creation information or chapter time layout. Examples of the object include images, video, voice, text, animation, and the like, and the object constitutes a multimedia scene (hereinafter, simply referred to as “scene”) using the MPEG decoder 120, which will be described below. The scene may be constructed by a composition of the objects that a user can watch and listen to, and may be composed of sub-scenes. Further, the scene or the sub-scenes may include organized nodes of a scene tree. The nodes build various types of MPEG UIs that constitute the scene. Furthermore, the object description may include at least one of initialization data, synchronization information, and information related to stream setup, all of which are used by the MPEG decoder 120.

The scene description includes information that is used to arrange the objects on a screen, effects that are applied to the objects output to the screen, a method of processing user interaction, a method of changing a scene, a control command to control a function of an apparatus, and the like. The information used to arrange the objects may include temporal and spatial information. For example, the temporal information may refer to temporal information of each of the objects within a threshold time on the screen, such as a time during which a predetermined object is added or deleted, a time when music starts and stops, or the like. The spatial information may be location information regarding how the objects are arranged on the screen. The user interaction refers to two-way data communication between the user and an application (that is, an MPEG UI) using an input device, such as a pointing device, a keyboard, a remote controller, or the like. The information included in the scene description may be described in a script (or class) language. Various kinds of events can be processed according to the description of the script. Therefore, when a predetermined event is generated by user interaction, the processing unit 140, which will be described below, can execute a corresponding function on the basis of the script corresponding to the event. The control of the function refers to controlling the apparatus hardware or software using the MPEG UI. For example, the hardware control may refer to controlling hardware elements (lighting on/off, temperature control, reserved recording, and the like) of the apparatus. Further, the software control may refer to controlling software elements (reproduction of moving pictures/audio files) of the corresponding apparatus. However, the hardware and software elements can be connected to each other and controlled in a predetermined module. Therefore, the hardware and software elements are not necessarily divided into two parts as described above.

The MPEG-4 Binary Format for Scene (BIFS) standard (hereinafter, simply referred to as “BIFS”) may be used as the standard for the scene description. Further, the Lightweight Applications Scene Representation (LASeR) is proposed by MPEG-4 and is used for mobile apparatuses. According to MPEG-4 as an object-oriented multimedia compression method, contents are divided into a plurality of objects that constitute a scene and then compressed. The BIFS includes information on the scene description in which the temporal and spatial arrangement of the objects can be expressed. Further, the BIFS can express the contents, which are composed of the objects, in the form of a scene tree having nodes on the basis of Virtual Reality Modeling Language (VRML), in which a three dimensional model is described in the form of a text document. At this time, each of the nodes may include information on visual characteristics of the object being rendered, a spatial position, a relative temporal position, a rule of change over time, and the like. Further, the scene tree may include information necessary for interaction between the nodes. The scene description of the MPEG data in the storage unit 110 may be dynamically updated. Therefore, information on the status of the apparatus or additional information that is dynamically generated may be added to the existing UI and expressed.

Additional information related to the object description, the scene description, and the MPEG-4 BIFS are described in the following documents, “Information Technology Coding of Audio—Visual Objects: ISO/IEC 14496, 2002 March” and “BIFS/OD Encoder version 4.0: ISO/IEC JTC1/SC29/WG11 MPEG99/M5950, November 1999”.

The MPEG decoder 120 decompresses the compressed MPEG data stored in the storage unit 110, composes objects (MPEG UIs) using the scene description and the object description included in the MPEG data, and renders the composed objects (MPEG UIs) to the output unit 130. That is, the MPEG decoder 120 can compose and render the objects according to the contents described in the scene description of the MPEG data such that the user can watch and listen to the composed and rendered objects. In such a manner, the scene is constructed. Here, each of the objects can serve as an MPEG UI.

The output unit 130 outputs the MPEG UIs to the screen of the apparatus. The user selects a predetermined MPEG UI to execute a corresponding function of the apparatus. Examples of the apparatus may include a portable multimedia apparatus, such as a cellular phone, a personal digital assistant (PDA), and an MP3 player, and a non-portable multimedia apparatus, such as a computer and a digital TV. The output unit 130 may be a module that includes an image display device, such as a Cathode Ray Tube (CRT), a Liquid Crystal Display (LCD), a Light-Emitting Diode (LED), an Organic Light-Emitting Diode (OLED), or a Plasma Display Panel (PDP).

The processing unit 140 controls the function corresponding to the MPEG UI. To this end, the processing unit 140 may include an interface unit 150. The interface unit 150 defines a command corresponding to the control command that is described in the scene description. Therefore, the processing unit 140 calls the control command and executes the command defined in the interface unit 150 that corresponds to the called control command, such that the function of the apparatus can be controlled. Further, the user can select the MPEG UI using an input device, such as a remote controller, a keyboard, or a touch screen. The function corresponding to the selected MPEG UI can be processed by the processing unit 140. When the function corresponding to the selected MPEG UI is described in the scene description as a change from a current scene to a sub-scene, if the user selects the corresponding MPEG UI, the current scene of the apparatus is changed into a new scene. That is, when the function corresponding to the MPEG UI is described in the scene description as a function that outputs a plurality of sub-menus, the current screen can be changed to a screen of the sub-menus. In such a manner, the current scene can be changed to the new scene, or a predetermined object in the current scene can be exchanged into a different object, transformed, and deleted.

Each of the components shown in FIG. 1 may be composed of a “module”. The term “module” according to the embodiments of the invention, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

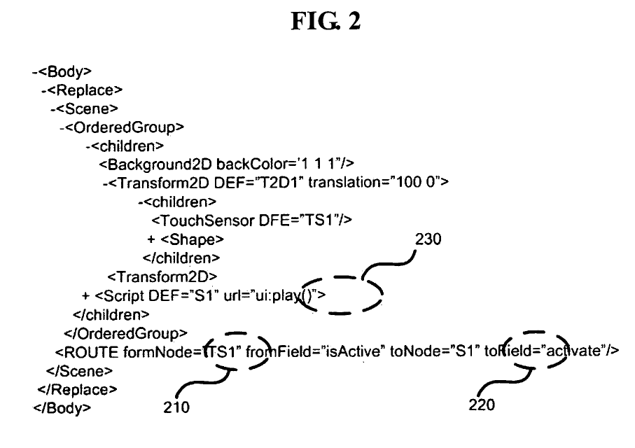

FIG. 2 is a diagram illustrating an example of a source code in the scene description.

A screen output to a display screen of an apparatus may be a composition of objects that a user can watch and listen to. Each of the objects may constitute the screen according to the temporal and spatial arrangement. For example, a person, sound of the person, a background, a logo on the screen, text, and the like are objects that can constitute a screen. To this end, the information that is used to arrange the objects on the screen and effects applied to the objects output to the screen are described in the scene description.

Further, since each of the objects that constitute the screen can serve as an MPEG UI, a predetermined function of the apparatus can be executed by two-way data communication with the user. To this end, the scene description may include description of a method of processing user interaction and a control command to control the function of the apparatus.

For example, when a speaker-like screen that is formed of an MPEG UI is displayed in a digital TV and a user selects the speaker using, for example, a touch screen or a remote controller, since a control command to control a corresponding function is described in scene description, the current volume of the TV and an UI object capable of controlling the TV volume appear. Then, a command defined in the interface unit 150 that corresponds to the control command is executed, such that the apparatus can be controlled.

In the scene description shown in FIG. 2, “TS1” 210 is used to execute “S1” 220, and the “S1” 220 is used to call “ui:play( )” 230. That is, when the user selects a predetermined MPEG UI, the “S1” 220 is executed by the corresponding “TS1” 210 in the scene description, and the “ui:play( )” 230 is called by the “S1” 220. The “ui:play( )” 230 may be regarded as a control command. The control command is used to execute a command corresponding to the control command in the interface unit 150. For example, the control command may be a function in relation to the operation of an air conditioner that is connected to the apparatus through a wired or wireless network. Further, according to the construction, the control command may be a function of reproducing moving pictures, audio, and video on the apparatus.

Therefore, according to the exemplary embodiment of the invention, when the apparatus is mounted with the MPEG decoder 120, a light-weight MPEG UI can be realized without using an additional module that implements an UI. This results in a reduction in the hardware overhead of the apparatus, and allows various types of UIs to be provided regardless of resolution of the apparatus and the function of the apparatus to be controlled using the MPEG UI.

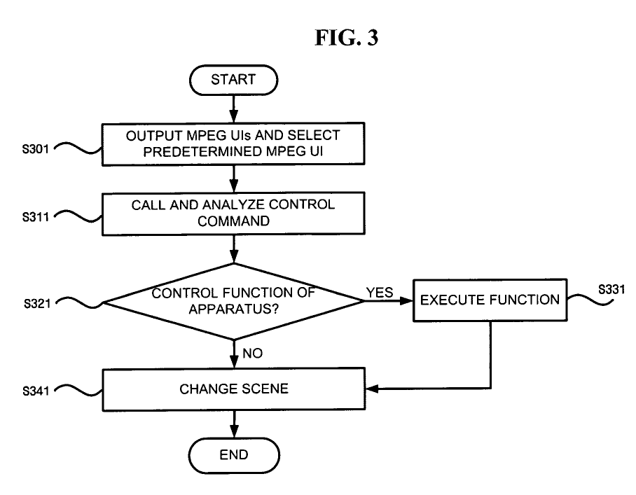

FIG. 3 is a flowchart illustrating a method of controlling a function using an MPEG UI according to an exemplary embodiment of the invention.

First, MPEG UIs are output to a screen, and a user selects a predetermined MPEG UI (Operation S301). That is, objects are composed and rendered according to the contents described in the scene description, and then constructed on the screen of the apparatus. The scene description may include information used to arrange each of the objects on the screen, effects applied to the objects output to the screen, a method of controlling user interaction, a method of changing a scene, a control command to control a function of the apparatus, and the like. The user selects a predetermined MPEG UI that is output to the screen.

Then, the processing unit 140 calls the control command described in the scene description that corresponds to the MPEG UI selected by the user, and analyzes the called control command (Operations S311 and S321).

When the called control command refers to controlling the function of the apparatus, the processing unit 140 executes a command corresponding to the control command that is defined by the interface unit 150 (Operation S331). After the function of the device is controlled, the current scene output to the screen is changed to a different scene and the different scene can be provided to the user. For example, a message indicating that the function of the corresponding device has been completely controlled may be output to the screen. At this time, the change of the scene means not only that the current scene is completely changed to the new screen but also that a new object is added to the current scene or a predetermined object of the current scene is deleted, exchanged into another object, and transformed.

When the called control command does not refer to controlling the function of the device, but simply to changing the scene, the current scene appearing on the screen may be changed to a different scene (Operation S341). For example, when the user selects a predetermined MPEG UI on the current scene, the scene is changed to sub-scenes of the current scene. At this time, the sub-scenes may include menus for controlling the function of the device.

Although the invention has been described in connection with the exemplary embodiments of the invention, it will be apparent to those skilled in the art that various modifications and changes may be made thereto without departing from the scope and spirit of the invention. Therefore, it should be understood that the above exemplary embodiments are not limitative, but illustrative in all aspects.

As described above, according to the MPEG-based user interface device and a method of controlling a function using the same according to the exemplary embodiments of the invention, the following effects may be obtained.

First, since the MPEG-based user interface (UI) device is provided, the hardware overhead of the apparatus can be reduced.

Second, a high-quality visual UI can be provided.

Third, the function of dynamically updating the scene description in the MPEG allows information on the status of the apparatus or dynamically generated additional information to be easily added to the existing UI and expressed.

What is claimed is:

1. A Moving Picture Experts Group (MPEG)-based user interface (UI) device comprising:
an output unit which outputs a UI based on MPEG data to a screen of an apparatus; and
a processing unit controlling a function corresponding to the UI.

2. The apparatus of claim 1, further comprising:
an MPEG decoder which renders the UI on the screen based on a scene description included in the MPEG data.

3. The apparatus of claim 2, wherein the scene description includes a control command to control a function of the apparatus.

4. The apparatus of claim 2, wherein the scene description complies with at least one of the MPEG-4 Binary Format for Scene (BIFS) standard and the Lightweight Applications Scene Representation (LASeR) standard.

5. The apparatus of claim 3, wherein the processing unit comprises an interface unit which defines a command corresponding to the control command.

6. The apparatus of claim 5, wherein the processing unit calls the control command and executes the command defined in the interface unit to control the function of the apparatus.

7. The apparatus of claim 1, wherein:
the UI constitutes a scene, and is added, deleted, changed, or transformed.

8. The apparatus of claim 1, wherein the UI is selected through two-way data communication with a user.

9. A method of controlling a function using a Moving Picture Experts Group (MPEG)-based user interface (UI), the method comprising:
outputting a UI based on MPEG data to a screen of an apparatus; and
controlling a function corresponding to the UI.

10. The method of claim 9, further comprising:
rendering the UI on the screen based on a scene description included in the MPEG data.

11. The method of claim 10, wherein the scene description includes a control command to control a function of the apparatus.

12. The method of claim 10, wherein the scene description complies with at least one of the MPEG-4 Binary Format for Scene (BIFS) standard and the Lightweight Applications Scene Representation (LASeR) standard.

13. The method of claim 10, further comprising:
calling the command control and executing a command corresponding to the control command to control the function of the apparatus.

14. The method of claim 9, wherein:
the UI constitutes a scene, and is added, deleted, changed, or transformed.

15. The method of claim 9, wherein the UI is selected through two-way data communication with a user.
